(19) United States
(12) Patent Application Publication
(10) Pub. No.: US 2011/0037731 A1
(43) Pub. Date: Feb. 17, 2011

(54) ELECTRONIC DEVICE AND OPERATING METHOD THEREOF

(75) Inventors: MING-HUA WANG, Shanghai City (CN); Li Yu, Shanghai City (CN); Tony Tsai, Taipei (TW)

Correspondence Address: J C PATENTS, 4 VENTURE, SUITE 250, IRVINE, CA, 92618, US

(73) Assignee: Inventec Appliances Corp., Taipei (TW)

(21) Appl. No.: 12/841,346

(22) Filed: Jul. 22, 2010

(30) Foreign Application Priority Data
Aug. 12, 2009 (TW) 98127108

(51) Int. Cl. G06F 3/042; G06F 17/30; G06F 3/033

(52) U.S. Cl. 345/175; 707/802; 715/863; 707/E17.044

(57) ABSTRACT

An electronic device and an operating method thereof are provided. The method firstly establishes a database recording at least one predefined operating gesture, a predefined function corresponding to the predefined operating gesture, and a specific color. An image captured by an image capturing unit of the electronic device is then obtained. When the specific color is found in the image, a position of the specific color is obtained and a gesture trajectory is displayed on a screen of the electronic device according to the position. The method repeats the steps of obtaining the image and displaying the gesture trajectory till it is unable to find the specific color in the currently obtained image. By referring to the database, the predefined function is then executed according to the predefined operating gesture which is determined by connecting the positions of the specific color in the obtained images.

### CROSS-REFERENCE TO RELATED APPLICATION

This application claims the priority benefit of Taiwan application serial no. 98127108, filed on Aug. 12, 2009. The entirety of the above-mentioned patent application is hereby incorporated by reference herein and made a part of this specification.

### BACKGROUND OF THE INVENTION

1. Field of the Invention

The present invention relates to an electronic device and an operating method thereof. Particularly, to an electronic device and an operating method thereof that can achieve gesture operating and handwriting input functions.

2. Description of Related Art

Along with the development of technology, electronic devices have been greatly improved both in function and in product appearance. For example, as the size of the mobile phones becomes smaller, however, the functions integrated therein become more diverse. Currently, in addition to the function of making phone call, the network access function, the audio/video file playing function, the photography function and the video recording function have also become basic functions of the mobile phones in the market.

The electronic devices have made progresses not only on the functions and appearance, but the operation method of the electronic device becomes more diverse in order to bring a better operating feeling to the user. In this regard, the electronic device equipped with a touch sensing element such as a touch screen or a touch pad can allow the user to achieve functions such as inputting characters and launching application program by directly touching the touch sensing element with a finger or a touch pen. Replacing the physical keys with the touch sensing element makes the input operation more intuitive and, at the same time, significantly reduces the time spent in learning how to operate the electronic device. However, for those electronic devices not equipped with the touch sensing element, the user has to input the characters or perform other operations by pressing the physical keys in a traditional manner.

### SUMMARY OF THE INVENTION

Accordingly, the present invention is directed to an operation method of an electronic device which facilitates operating the electronic device.

The present invention is also directed to an electronic device which can offer the convenience of gesture operating and handwriting input without adding any touch sensing element.

The present invention provides an operating method of an electronic device for use in an electronic device with an image capturing unit and a screen. The method firstly establishes a database. The database records at least one predefined operating gesture, a predefined function corresponding to the predefined operating gesture, and a specific color. An image captured by the image capturing unit is then obtained. A position of the specific color in the image is obtained if the specific color is found in the image, and a gesture trajectory is displayed on the screen according to the position. The steps of obtaining the image and displaying the gesture trajectory are repeated till the specific color is not found in the image which is obtained currently, and then the predefined function is executed according to the predefined operating gesture which is determined by connecting the positions of the specific color in each of the obtained images by referring to the database.

In another embodiment of the present invention, an electronic device includes a screen, an image capturing unit, a storage unit and a processing unit. The storage unit stores therein a database, the database recording at least one predefined operating gesture, a predefined function corresponding to the predefined operating gesture, and a specific color. The processing unit is coupled to the screen, the image capturing unit and the storage unit. The processing unit is adapted for obtaining an image captured by the image capturing unit, obtaining a position of the specific color in the image if the specific color is found in the image, and displaying a gesture trajectory on the screen according to the position. The processing unit repeats procedures of obtaining the image and displaying the gesture trajectory till the specific color is not found in the image which is obtained currently, and then refers to the database to execute the predefined function according to the predefined operating gesture which is determined by connecting the positions of the specific color in each of the obtained images.

In view of the foregoing, the present invention captures the user's operating gesture by capturing images of the user. When the user continuously operates the electronic device with gesture operations, the gesture trajectory is displayed on the screen. When the user stops the gesture operating, the function corresponding to the operating gesture is executed. As such, even though the electronic device is not equipped with any touch sensing element, the electronic device can still bring the convenience of handwriting input and starting specific function by gesture operating to the user.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of an electronic device according to one embodiment of the present invention.

FIG. 2 is a flow chart of an operating method of an electronic device according to one embodiment of the present invention.

FIG. 3 is a detail flow chart of displaying the gesture trajectory of step 240.

FIG. 4 is a detail flow chart of executing the predefined function according to the predefined operating gesture of step 250.

### DESCRIPTION OF THE EMBODIMENTS

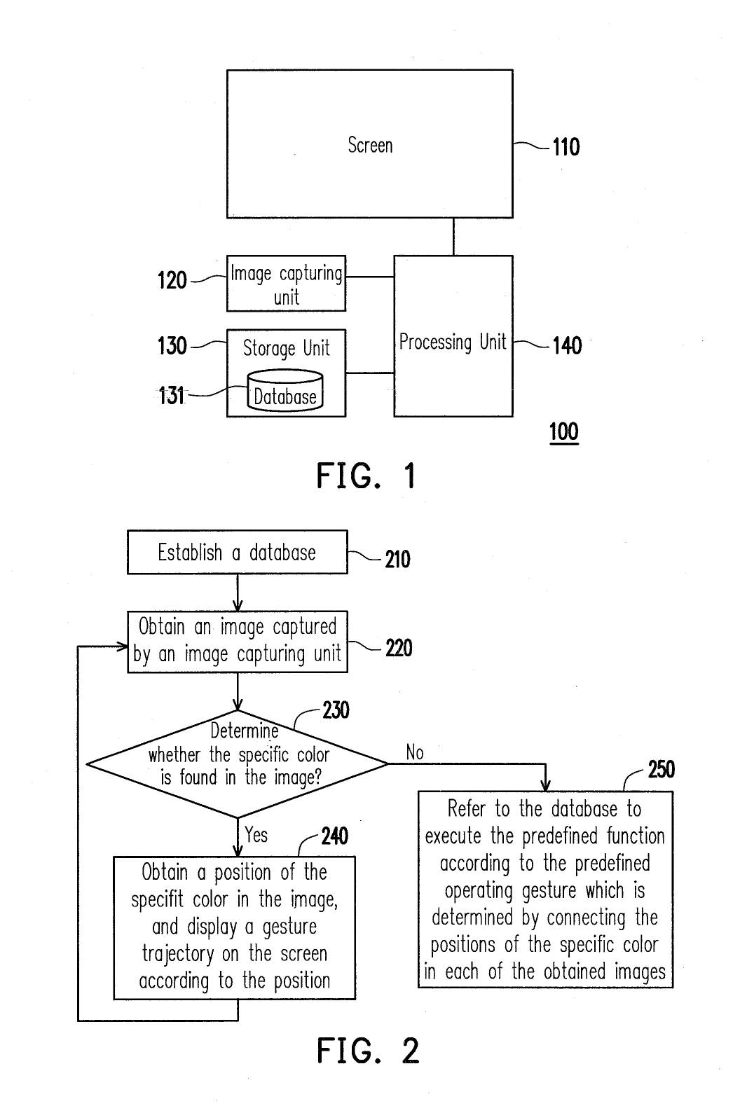

FIG. 1 is a block diagram of an electronic device according to one embodiment of the present invention. Referring to FIG. 1, the electronic device includes a screen 110, an image capturing unit 120, a storage unit 130, and a processing unit 140. In the present embodiment, the electronic device 100 may be a mobile phone, a personal digital assistant (PDA), a smart phone, a computer system, or a home appliance. Therefore, the present embodiment is not intended to limit the electronic device 100 to any particular form described herein.

The screen 110 may be a liquid crystal display or a touch screen, for displaying an operating image of the electronic device 100. The image capturing unit 120 may be a camera or a video camera with a video capturing function. The storage unit 130 may be a data storage device such as a memory or a memory card. In the present embodiment, the storage unit 130 stores therein a database 131 that records at least one predefined operating gesture, a predefined function corresponding to the predefined operating gesture, and one specific color. The selection of the specific color and a relationship between the predefined operating gesture and the predefined function may be determined by the user.

The processing unit 140 is connected to the screen 110, the video capturing unit 120 and the storage unit 130. The processing unit 140 is, for example, a hardware component (e.g. chipset) with operational and processing capabilities, a software component, or a combination of hardware and software components. The processing unit 140 obtains and processes images captured by the image capturing unit 120. When the image capturing unit 120 captures the image of the user holding a tool (e.g. light pen, fluorescent pen, laser pen) capable of emitting a light of the specific color and performing an operating gesture, the processing unit 140 then displays a gesture trajectory on the screen 110. In addition, when the processing unit 140 determines that the user has finished the predefined operating gesture, a corresponding function is executed by referring to the database 131.

As described above, the processing unit 140 recognizes the user's operating gesture by detecting the specific color trajectory in multiple images. That is, the user can remotely operate the electronic device 100 without directly touching the electronic device 100 as long as the user holds a tool capable of emitting a light of the specific color and within the coverage of the image capturing unit 120, thus greatly facilitating the operation of the electronic device 100.

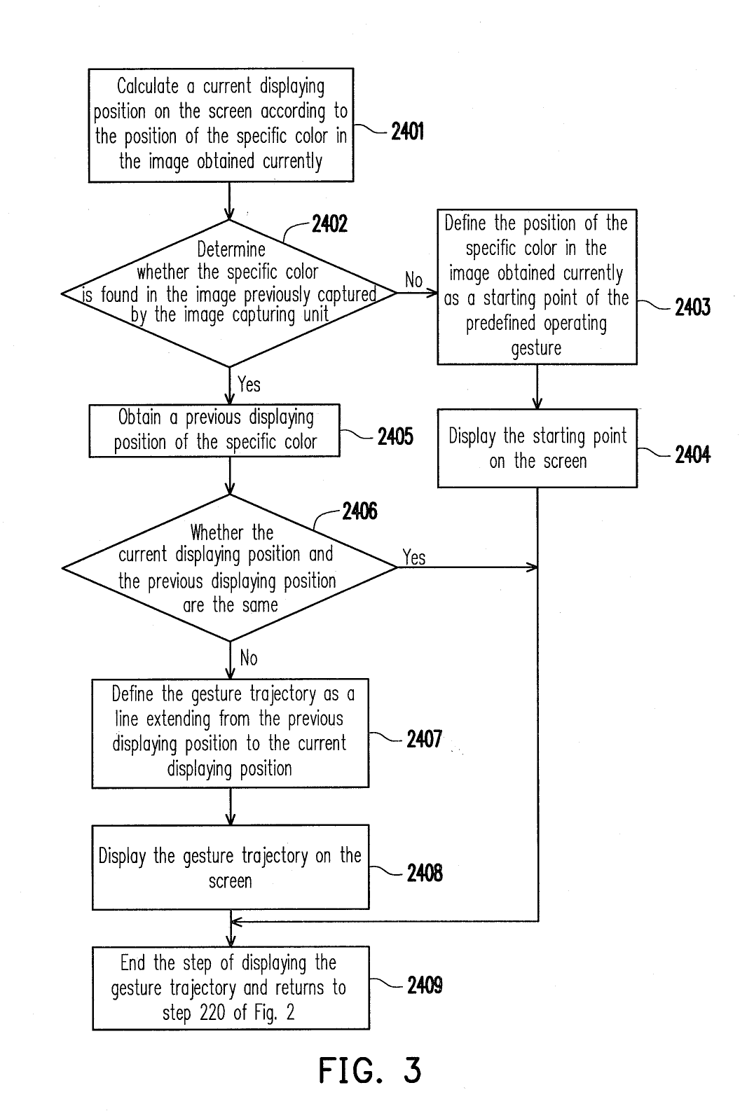

The present invention is described below in conjunction with another embodiment in which a method of achieving handwriting input in the electronic device 100 is further explained. FIG. 2 is a flow chart of an operating method of an electronic device according to one embodiment of the present invention. Referring to FIGS. 1 and 2, the database 131 is first established at step 210.

In the present embodiment, the user may press a specific key of the electronic device 100 or launch specific application program to trigger a database establishing instruction. When the database establishing instruction is triggered, the processing unit 140 first determines a specific color as a reference for later operating gesture recognition. The processing unit 140 then obtains a predefined operating gesture and a corresponding predefined function inputted by the user, and establishes the relationship between the predefined operating gesture and the predefined function into the database 131.

When determining the specific color, the processing unit 140 first obtains a pre-processing image captured by the image capturing unit 120. The processing unit 140 then analyzes a pixel color distribution of the pre-processing image to obtain at least one candidate color from the colors of the pixels of the pre-processing image. Each candidate color is different from the color of corresponding surrounding pixels and the area ratio of the pixels of each candidate color in the pre-processing image satisfies a specific condition. For example, assuming that the pre-processing image has a size of 320×240, the specific condition may be, for example, a range from 2×2/320×240 to 30×30/320×240. In the present embodiment, after obtaining the candidate colors, the processing unit 140 may display all the candidate colors on the screen 110 in the form of a menu allowing the user to select. Finally, the processing unit 140 selects one of the candidate colors as the specific color according to a selecting instruction relevant to the user selection and records the specific color.

Obtaining the predefined operating gesture and establishing the relationship between the predefined operating gesture and the predefined function are explained as follow. Firstly, the processing unit 140 obtains a pre-processing image captured by the image capturing unit 120. When the determined specific color can be found in the pre-processing image, the processing unit 140 records a position of the specific color in the pre-processing image. The processing unit 140 repeatedly obtains a next pre-processing image and records the position of the specific color till the specific color cannot be found in the currently captured pre-processing image. At this time, a line connecting all the recorded positions are defined as the predefined operating gesture inputted by the user and the first recorded position is defined as a starting point of the predefined operating gesture.

After obtaining the predefined operating gesture, the processing unit 140 converts the predefined operating gesture into a corresponding predefined representation. For example, the processing unit 140 may convert the predefined operating gesture into a character, a symbol, a vector combination, or a normalized thumbnail with a fixed size. After the user inputs a predefined function, the processing unit 140 makes the predefined operating gesture correspond to the predefined function inputted by the user, and then records the relationship between the predefined function and the predefined representation corresponding to the predefined operating gesture into the database 131. Each time the user wants to define a new predefined operating gesture, the processing unit 140 records the predefined function and the predefined representation corresponding to the predefined operating gesture into the database 131 in the same manner as described above.

After establishing the database 131, the processing unit 140 obtains an image captured by the image capturing unit 120 at step 220. At step 230, it is determined that whether the predefined specific color (i.e. the specific color recorded in the database 131) is found in the image. If the specific color is found in the image, it indicates that, at the time of capturing the image, the user is located within the coverage of the image capturing unit 120 and holds a tool capable of emitting a light of the specific color. In this case, at step 240, the processing unit 140 obtains a position of the specific color in the image and displays a gesture trajectory on the screen 110 according to the position, wherein the details of step 240 will be described thereafter.

The operating method of the electronic device then returns to step 220. The processing unit 140 repeatedly executes the steps 220 to 240 to obtain a next image captured by the image capturing unit 120 and displays a gesture trajectory on the screen 110 when the specific color can be found in the image. The processing unit 140 continues these steps till it is determined that the specific color is not found in a currently obtained image (e.g. because the user shields the tool capable of emitting the light of the specific color in front of the image capturing unit 120 in a certain manner), which indicates that the user has finished an entire operating gesture. In this case, at step 250, the processing unit 140 refers to the database 131 to execute the predefined function according to the predefined operating gesture which is determined by connecting the positions of the specific color in each of the obtained images.

As shown in FIG. 2, when the user holds a tool capable of emitting a light of the specific color and makes a gesture in front of the image capturing unit 120, the electronic device 100 executes the predefined function according to a trajectory of positions of the specific color in the continuously captured images. As such, even though the electronic device 100 is not equipped with any touch sensing elements, the user can still enjoy the convenience of gesture operating.

FIG. 3 is a detail flow chart of displaying the gesture trajectory of step 240. The embodiment below explains how the processing unit 140 displays the gesture trajectory on the screen 110 before the predefined operating gesture input is finished.

Firstly, at step 2401, the processing unit 140 calculates a current displaying position on the screen 110 according to the position of the specific color in the currently obtained image. At step 2402, the processing unit 140 determines whether the specific color is found in the image previously captured by the image capturing unit 120. If the specific color is not found in the previously captured image, this indicates that the user is just starting to input an operating gesture. Thus, the processing unit 140 defines the position of the specific color in the currently obtained image as the starting point of the predefined operating gesture at step 2403. At step 2404, the processing unit 140 displays the starting point of the predefined operating gesture overlappingly on the screen 110 according to the calculated displaying position at step 2401. For example, the processing unit 140 may mark the starting point with a specific color on the screen 110. Then, in step 2409, the step of displaying the gesture trajectory ends and the method returns to step 220 of FIG. 2 to obtain a next image captured by the image capturing unit 120.

On the other hand, if the specific color is found in the previously captured image, this indicates that the user is now continuously inputting the predefined operating gesture. Thus, the processing unit 140 obtains a previous displaying position (the previous displaying position is the position of the specific color appears in the previously captured image) of the specific color on the screen 110 and, at step 2406, the processing unit 140 determines whether the current displaying position and the previous displaying position are the same. If the two displaying positions are the same, this indicates that the user did not move the tool capable of emitting the light of the specific color. That is, the gesture was not varied. Thus, at step 2409, the step of displaying the gesture trajectory ends and the method returns to step 220 of FIG. 2 to obtain a next image captured by the image capturing unit 120.

If the current displaying position is different from the previous displaying position, this indicates that the user moved the tool. Thus, the processing unit 140 defines the gesture trajectory as a line extending from the previous displaying position to the current displaying position and, at step 2408, the processing unit 140 displays the gesture trajectory overlappingly on the screen 110. The gesture trajectory may be, for example, displayed with a specific color in the operating image. Then, at step 2409, the step of displaying the gesture trajectory ends and the method returns to step 220 of FIG. 2 to obtain a next image captured by the image capturing unit 120.

It is noted that, when determining that the user is continuously inputting an operating gesture, the processing unit 140 does not directly display the image captured by the image capturing unit 120 on the screen 110 but only displays the gesture trajectory on the screen 110 instead. As such, the user not only can confirm whether the inputted operating gesture is correct through the gesture trajectory, but also can continue to view the content in the operating image.

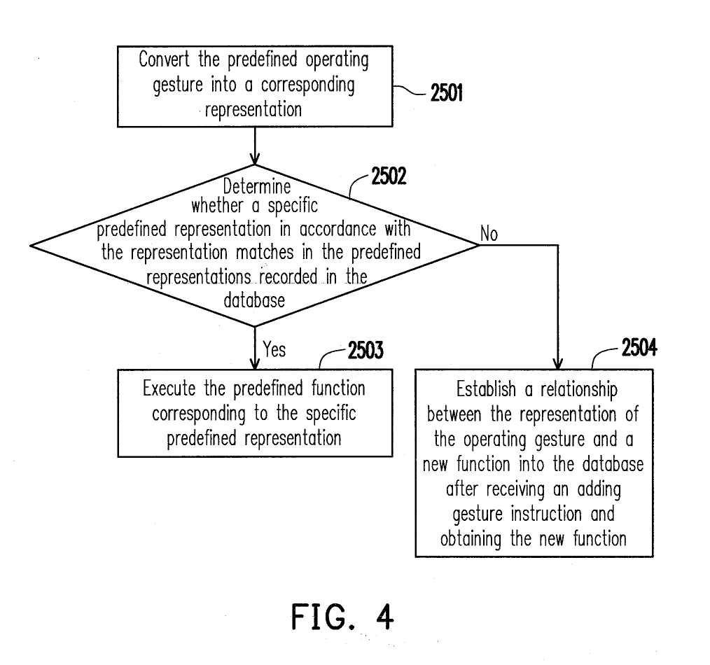

After the user has finished the predefined operating gesture input, the following operation performed by the processing unit 140 is described below in detail. Referring to FIG. 4, firstly, at step 2501, the processing unit 140 converts the predefined operating gesture into a corresponding representation. For example, the processing unit 140 may convert the predefined operating gesture into a character, a symbol, a vector combination, or a normalized thumbnail.

At step 2502, the processing unit 140 then determines whether a specific predefined representation in accordance with the representation matches in the predefined representations recorded in the database 131.

If the specific predefined representation matches in the predefined representations recorded in the database 131, this indicates that the database 131 records a predefined operating gesture that matches the operating gesture currently inputted by the user. Thus, at step 2503, the predefined function corresponding to the specific predefined representation is executed. However, some operating gestures may have a same trajectory pattern but have a different direction. Therefore, in an alternative embodiment, after determining that the database 131 records the above specific predefined representation, the processing unit 140 further determines whether the starting point of the predefined operating gesture corresponding to the specific predefined representation coincides with the starting point of currently inputted operating gesture. The predefined function corresponding to the specific predefined representation is executed only if the two starting points coincide with each other. The predefined function may be a character input function, a number input function, a symbol input function, a cursor operating function, a shortcut key input function, an application program launching function or the like. It is noted that the present embodiment is not intended to limit the predefined function to any particular function described herein.

On the other hand, if the specific predefined representation does not match in the predefined representations recorded in the database 131, then at step 2504, the processing unit 140 establishes a relationship between the representation of the operating gesture and a new function into the database 131 after receiving a gesture adding instruction and obtaining the new function. Specifically, when the processing unit 140 determines that the predefined data matching with the operating gesture currently inputted by the user cannot be found in the database 131, a gesture defining interface may be displayed on the screen 110 for allowing the user to choose whether to define a function corresponding to this operating gesture or cancel this operating gesture. When the user chooses to define a function corresponding to this operating gesture, the gesture defining interface triggers a gesture adding instruction. The processing unit 140 then prompts the user to input a desired new function and records the relationship between the operating gesture and the new function into the database 131.

The user is allowed to define the relationship between an operating gesture and a specific function, which makes the predefined data recorded in the database 131 more comply with the operating habits of the user. After finding the predefined data that matches with the operating gesture by comparing with the database 131, the processing unit 140 directly executes the corresponding function. When the matching data cannot be found, it is determined whether to add the operating gesture to the database 131 according to the user choice. As such, the present invention not only facilitates the operation of the electronic device 100, but also can increase the number of the operating gestures thus making the operating process more flexible.

In the above embodiments, the user can make the electronic device 100 enter an editing mode or a normal operating mode by pressing a specific key or launching specific application program of the electronic device 100. When the electronic device 100 is in the editing mode and after the processing unit 140 compares with the database 131 and obtains the matching data, the function executed by the processing unit 140 is the character input function, number input or symbol input functions. That is, the user can experience the operating feeling of handwriting input. When the electronic device 100 is in the normal operating mode, after the processing unit 140 compares with the database 131 and obtains the matching data, the executed function includes the curse operating function, shortcut input function, or application program launching function, which allows the user to operate the electronic device 100 through gestures.

In summary, the electronic device and the operating method thereof allow the user to define various operating gestures and corresponding functions. When the user holds a tool capable of emitting a light of the specific color and stands in front of the electronic device to make an operating gesture, the electronic device is able to recognize the type of the gesture using an image capturing method. The processing unit displays the gesture trajectory on a screen and, after the user has finished the gesture input, the processing unit refers to the database to execute a corresponding function. As such, even though the electronic device is not equipped with any touch sensing element, the electronic device can still provide the user with the gesture operating and handwriting input functions. Thus, the present invention can greatly facilitate the use of the electronic device without increase the hardware cost of the electronic device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An operating method of an electronic device, the electronic device comprising an image capturing unit and a screen, the operating method comprising:
establishing a database for recording at least one predefined operating gesture, a predefined function corresponding to the predefined operating gesture, and a specific color;
obtaining an image captured by the image capturing unit;
obtaining a position of the specific color in the image if the specific color is found in the image, and displaying a gesture trajectory on the screen according to the position; and
repeating the steps of obtaining the image and displaying the gesture trajectory till the specific color is not found in the image which is obtained currently, and then referring to the database to execute the predefined function according to the predefined operating gesture which is determined by connecting the positions of the specific color in each of the obtained images.

2. The operating method of an electronic device according to claim 1, wherein the step of obtaining the position and displaying the gesture trajectory comprises:
calculating a current displaying position on the screen according to the position of the specific color in the image obtained currently;
determining whether the specific color is found in the image previously captured by the image capturing unit;
if the specific color is found in the image captured previously, obtaining a previous displaying position on the screen corresponding to the position of the specific color in the image captured previously;
if the current displaying position is different from the previous displaying position, defining the gesture trajectory as a line extending from the previous displaying position to the current displaying position; and
overlappingly displaying the gesture trajectory on the screen.

3. The operating method of an electronic device according to claim 2, wherein, after the step of determining whether the specific color is found in the image previously captured by the image capturing unit, the operating method further comprises:
if the specific color is not found in the image captured previously, defining the position of the specific color in the image obtained currently as a starting point of the predefined operating gesture; and
overlappingly displaying the starting point on the screen.

4. The operating method of an electronic device according to claim 1, wherein the step of establishing the database comprises:
obtaining a database establishing instruction;
determining and recording the specific color;
after obtaining the predefined operating gesture, converting the predefined operating gesture into a corresponding predefined representation and defining the predefining function corresponding to the predefined operating gesture; and
recording a relationship between the predefined function and the predefined representation corresponding to the predefined operating gesture into the database.

5. The operating method of an electronic device according to claim 4, wherein the step of determining the specific color comprises:
obtaining a pre-processing image captured by the image capturing unit;
analyzing a pixel color distribution of the pre-processing image to obtain at least one candidate color, wherein each of the at least one candidate color is different from the color of surrounding pixels and the area ratio of each of the at least one candidate color in the pre-processing image satisfies a specific condition; and
selecting one of the at least one candidate color as the specific color according to a selecting instruction.

6. The operating method of an electronic device according to claim 4, wherein the step of obtaining the predefined operating gesture comprises:
obtaining a pre-processing image captured by the image capturing unit;
if the specific color is found in the pre-processing image, recording the position of the specific color in the pre-processing image; and
repeating the steps of obtaining the pre-processing image and recording the position till the specific color is not found in the pre-processing image obtained currently, and then defining a line connecting all the recorded positions as the predefined operating gesture and defining the first recorded position as a starting point of the predefined operating gesture.

7. The operating method of an electronic device according to claim 4, wherein the step of referring to the database to execute the predefined function according to the predefined operating gesture comprises:
converting the predefined operating gesture into a corresponding representation;
determining whether a specific predefined representation in accordance with the representation matches in the predefined representations recorded in the database; and
if the specific predefined representation matches in the predefined representations recorded in the database, executing the predefined function corresponding to the specific predefined representation.

8. The operating method of an electronic device according to claim 7, wherein, after the step of determining whether the specific predefined representation matches in the predefined representations recorded in the database, the operating method further comprises:
if the specific predefined representation matches in the predefined representations recorded in the database and a starting point of the predefined operating gesture corresponding to the specific predefined representation coincides with the starting point of the predefined operating gesture, executing the predefined function corresponding to the specific predefined representation.

9. The operating method of an electronic device according to claim 7, wherein, after the step of determining whether the specific predefined representation matches in the predefined representations recorded in the database, the operating method further comprises:
if the specific predefined representation does not match in the predefined representations recorded in the database, establishing a relationship between the representation of the operating gesture and a new function into the database after receiving an gesture adding instruction and obtaining the new function.

10. The operating method of an electronic device according to claim 7, wherein the predefined representation and the representation comprises a character, a symbol, a vector combination or a normalized thumbnail, when the electronic device is in an editing mode, the predefined function comprises a character input function, a number input function or a symbol input function, when the electronic device is in a normal operating mode, the predefined function comprises a cursor operating function, a shortcut key input function, or an application program launching function.

11. An electronic device comprising:
a screen;
an image capturing unit;
a storage unit for storing a database, the database records at least one predefined operating gesture, a predefined function corresponding to the predefined operating gesture, and a specific color; and
a processing unit coupled to the screen, the image capturing unit and the storage unit, wherein the processing unit is adapted for obtaining an image captured by the image capturing unit, obtaining a position of the specific color in the image if the specific color is found in the image, and displaying a gesture trajectory on the screen according to the position;
wherein the processing unit repeats procedures of obtaining the image and displaying the gesture trajectory till the specific color is not found in the image which is obtained currently, and then refers to the database to execute the predefined function according to the predefined operating gesture which is determined by connecting the positions of the specific color in each of the obtained images.

12. The electronic device according to claim 11, wherein the processing unit calculates a current displaying position on the screen according to the position of the specific color in the image obtained currently, determines whether the specific color is found in the image previously captured by the image capturing unit,
if the specific color is found in the image captured previously, the processing unit obtains a previous displaying position on the screen corresponding to the position of the specific color in the image captured previously,
if the current displaying position is different from the previous displaying position, the processing unit defines the gesture trajectory as a line extending from the previous displaying position to the current displaying position, and overlappingly displays the gesture trajectory on the screen.

13. The electronic device according to claim 12, wherein if the specific color is not found in the image captured previously, the processing unit defines the position of the specific color in the image obtained currently as a starting point of the predefined operating gesture, and overlappingly displays the starting point on the screen.

14. The electronic device according to claim 11, wherein the processing unit determines and records the specific color after obtaining a database establishing instruction,
after obtaining the predefined operating gesture, the processing unit converts the predefined operating gesture into a corresponding predefined representation and defines the predefining function corresponding to the predefined operating gesture, and records a relationship between the predefined function and the predefined representation corresponding to the predefined operating gesture into the database.

15. The electronic device according to claim 14, wherein the processing unit obtains a pre-processing image captured by the image capturing unit, analyzes a pixel color distribution of the pre-processing image to obtain at least one candidate color and selects one of the at least one candidate color as the specific color according to a selecting instruction, wherein each of the at least one candidate color is different from the color of surrounding pixels and the area ratio of each of the at least one candidate color in the pre-processing image satisfies a specific condition.

16. The electronic device according to claim 14, wherein the processing unit obtains a pre-processing image captured by the image capturing unit, if the specific color is found in the pre-processing image, the processing unit records the position of the specific color in the pre-processing image,
the processing unit repeats procedures of obtaining the pre-processing image and recording the position till the specific color is not found in the pre-processing image obtained currently, and then defines a line connecting all the recorded positions as the predefined operating gesture and defines the first recorded position as a starting point of the predefined operating gesture.

17. The electronic device according to claim 14, wherein the processing unit converts the predefined operating gesture into a corresponding representation, determines whether a specific predefined representation in accordance with the representation matches in the predefined representations recorded in the database,
if the specific predefined representation matches in the predefined representations recorded in the database, the processing unit executes the predefined function corresponding to the specific predefined representation.

18. The electronic device according to claim 17, wherein if the specific predefined representation matches in the predefined representations recorded in the database and a starting point of the predefined operating gesture corresponding to the specific predefined representation coincides with the starting point of the predefined operating gesture, the processing unit executes the predefined function corresponding to the specific predefined representation.

19. The electronic device according to claim 17, wherein if the specific predefined representation does not match in the predefined representations recorded in the database, the processing unit establishes a relationship between the representation of the operating gesture and a new function into the database after receiving an gesture adding instruction and obtaining the new function.

20. The electronic device according to claim 17, wherein the predefined representation and the representation comprises a character, a symbol, a vector combination or a normalized thumbnail, when the electronic device is in an editing mode, the predefined function at least comprises a character input function, a number input function or a symbol input function, when the electronic device is in a normal operating mode, the predefined function comprises a cursor operating function, a shortcut key input function, or an application program launching function.
